(19) United States
(12) Patent Application Publication
(10) Pub. No.: US 2013/0229492 A1
(43) Pub. Date: Sep. 5, 2013

(54) METHOD AND APPARATUS FOR AN OPERATING UNIT FOR A HOME APPLIANCE

(71) Applicant: E.G.O. ELEKTRO-GERAETEBAU GMBH, Oberderdingen (DE)

(72) Inventors: Lutz Ose, Sternenfels (DE); Markus Jungbauer, Bruchsal-Obergrombach (DE)

(73) Assignee: E.G.O. ELEKTRO-GERAETEBAU GMBH, Oberderdingen (DE)

(21) Appl. No.: 13/785,711

(22) Filed: Mar. 5, 2013

(30) Foreign Application Priority Data
Mar. 5, 2012 (DE) 10 2012 203 458.7

(51) Int. Cl. G06F 3/01

(52) U.S. Cl. CPC G06F 3/017
USPC 348/46; 348/77

(57) ABSTRACT

An offset operating unit for a home appliance includes a camera, an evaluation unit which evaluates picture data generated by the camera for recognition of an operating gesture from a predefined set of operating gestures, wherein the operating gestures serve for operator control of the home appliance, wherein the home appliance includes a control device for function control spaced apart from the operating unit, an interface for wireless data transmission between the operating unit and the control device, wherein information regarding the recognized operating gesture is transmitted to the control device via the interface in a wireless manner, and a housing in which the camera, the evaluation unit and the interface are integrated.

### CROSS-REFERENCE TO RELATED APPLICATIONS

This application claims priority to German Application No. 10 2012 203 458.7, filed Mar. 5, 2012, the contents of which are hereby incorporated herein in its entirety by reference.

### TECHNOLOGICAL FIELD

The invention relates to an operating unit for a home appliance.

### BACKGROUND

Operating units being deposited, spaced or offset from an operated device (in the following called offset operating unit) allow a comfortable operation control of home appliances, wherein multiple home appliances can be operation controlled by means of one single operating unit.

Generally, such offset operating units comprise keys, buttons, rotary knobs, etc. which allow an entry of operating commands.

### BRIEF SUMMARY

The object underlying the invention is to provide an offset operating unit for a home appliance which allows a most comfortable operation control of the home appliance.

The invention achieves this object by means of an operating unit.

The offset or deposited operating unit for a home appliance comprises: a camera, for example having a camera chip and associated optics, an evaluation unit, for example in the form of a microprocessor, which evaluates picture data generated by the camera for recognition of an operating gesture from a predefined set of operating gestures, wherein the operating gestures serve for operator control of the home appliance, wherein the home appliance comprises a control device or control unit spaced apart from the operating unit, a bidirectional or unidirectional interface for wireless data transmission between the operating unit and the control device, wherein information regarding the recognized operating gesture is transmitted to the control device via the interface in a wireless manner, and a housing in which the camera, the evaluation unit and the interface are integrated.

In particular, an offset operating unit refers to a portable operating unit corresponding to a remote control which in the operation mode is not coupled to the home appliance to be controlled or the control device thereof by direct or galvanic couple. For example, the offset operating unit can be arranged on a functional position provided therefor on a housing of the home appliance.

The operating unit preferably comprises all components and functions for a gesture operation control and thus forms a gesture control user interface which can be coupled to the control device of the home appliance in a wireless manner. Via the wireless interface between the operating unit and the control device of the home appliance, preferably merely basic information in the form of generic operating data is transmitted. This is to allow that the control device does not need to perform any calculations or the like for recognizing the operating gesture. In the operating unit, a number of predefined operating gestures can be stored. Upon recognition of an operating gesture, for example only the identifier of the operating gesture and the X-, Y- and Z-position of a finger and/or of a hand of an operator who performs the operating gesture are transmitted via the wireless interface. With some operating gestures, there is a contingency that an appropriate correlation of such position data is not possible.

By means of one of the operating gestures, for example a cooking area of a cooktop having multiple cooking areas can be selected, and subsequently by means of another of the operating gestures, a desired heating capacity of the cooktop can be set. Furthermore, specific functions of the home appliance can be selected or activated, for example in the form of a program setting, a program parameter setting, etc.

The operating unit can comprise an energy supply unit for generation of operating energy for the operating unit from an externally-generated alternating magnetic field by means of which an inductive power supply is made possible. The operating unit can be operated without batteries.

The operating unit can comprise a controllable illuminant, wherein the evaluation unit synchronizes the illuminant and the camera. For example, the controllable illuminant can be an infrared illuminant, wherein, in the simplest case, controllable refers to adapted to be switched-on and switched-off. The evaluation unit can effect the actuation of the illuminant, for example synchronically with a so-called shutter of the camera. This can be advantageous since the illuminant generates a light pulse only at the instant the camera takes a picture.

Alternatively, the illuminant can be provided separate from the operating unit, for example underneath a glass-ceramics cooktop, wherein the evaluation unit synchronizes the camera and a controllable illuminant provided externally in relation to the control device, for example by means of wireless transmission of a synchronization signal.

The housing can comprise a support device by means of which the operating unit can be fixed for example to a housing of the home appliance, a cooktop and/or an extractor hood.

The camera can be a 2-dimensional (2D) camera or a 3-dimensional (3D) camera, for example a so-called Time-Of-Flight camera or a stereo camera.

For example, the wireless interface can be an infrared interface, a Wireless Local Area Network (WLAN) interface or a Bluetooth interface.

### BRIEF DESCRIPTION OF THE SEVERAL VIEWS OF THE DRAWING

The invention is subsequently described with reference to the drawing which shows embodiments of the invention. In a schematic illustration is shown in:

FIG. 1 an offset operating unit according to the invention for a home appliance.

### DETAILED DESCRIPTION

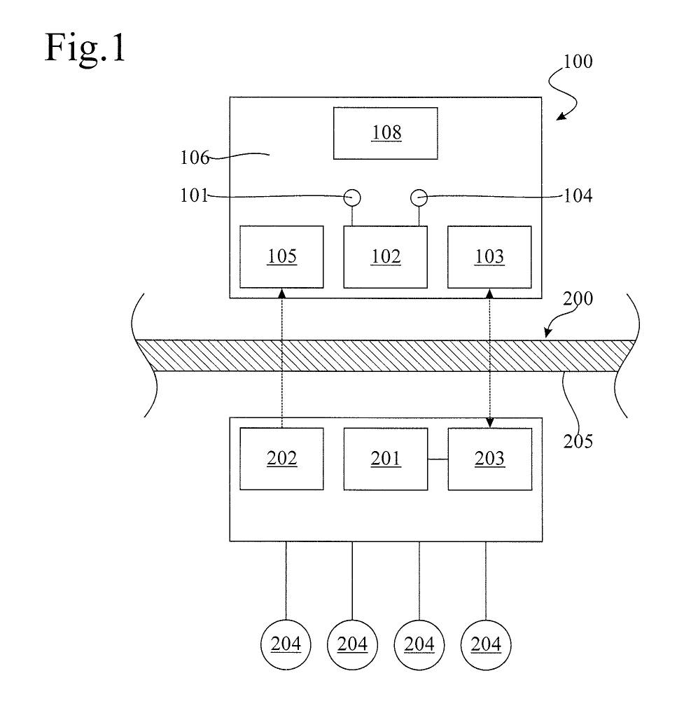

FIG. 1 shows an offset operating unit 100 according to the invention for offset operation control or remote control of a home appliance 200.

The home appliance 200 in the form of an electric stove shown in FIG. 1 comprises a control device 201, for example in the form of a microcontroller, which serves for function control of the home appliance 200 for example by suitable control of actuators, in this case heating means 204, reading-out of sensors, realizing of control loops, executing of program sequences which can be selected by the user, etc. It is understood that the operating unit 100 can also be used for example for the operator control of a washing machine, a laundry drier, etc. The operating unit can also serve to operate multiple home appliances.

The operating unit 100 comprises a conventional 2D camera or 3D camera 101, an evaluation unit 102, for example in the form of a microcontroller or of a FPGA which evaluates picture data generated by the camera 101 for recognition of an operating gesture from a predefined set of operating gestures, an infrared (IR) illuminant 104 actuated by the evaluation unit 102, a wireless, bidirectional IR interface 103 for coupling of the operating unit 100 to the control device 201 via a correspondent, bidirectional IR interface 203, a display 108 for displaying operational parameters, an energy supply unit 105, and a housing 106 in which the aforementioned components are integrated.

The energy supply unit 105 serves for generating operating energy for the operating unit 100 from an alternating magnetic field which is generated by means of a power source 202 of the home appliance 200.

The predefined set of operating gestures serves for operator control of the home appliance 200, wherein the set can comprise the following gestures: pointing by means of the forefinger, closed hand, splayed fingers, fist, fist with thumb on the right side or on the left side, etc. A unique operating gesture identifier is assigned to each operating gesture from the predefined set of operating gestures.

In addition to the actual operating gesture, the operating unit 100 recognizes associated position information and/or direction information, for example X-coordinates and Y-coordinates to which a finger of a hand of an operating person points, X-coordinates and Y-coordinates of the hand, and a Z-coordinate of the hand, as the case may be. For determination of the Z-coordinate, a 3D-camera can be used. As an alternative, a (pseudo) Z-coordinate can be determined by means of a 2D-camera by evaluating a size change of the hand. When the hand is recognized by the camera for the first time, a default Z-coordinate can be defined which is then changed in response to a relative size change of the hand detected in the camera 101.

Upon recognition of an operating gesture by means of the operating unit 100, the associated operating gesture identifier as well as associated position information, as the case may be, are transmitted to the control device 201 via the interface 103 in a wireless manner. The control device 201 correspondingly implements the operating gesture in connection with the available position information, as the case may be, for example by starting a function of the home appliance 200 associated to the gesture, by selecting a cooking area, by changing a desired value, etc.

For example, the operating unit 100 can be arranged on a predefined position on a glass-ceramics plate 205 of the home appliance, wherein for example correspondent (not shown) magnetic fixation means can be provided in the operating unit 100 and underneath the glass-ceramics plate 205, which effect a detachable fixation and orientation of the operating unit on the glass-ceramics plate 205.

The IR illuminant 104 can alternatively also be provided underneath the glass-ceramics 205 plate translucent for IR light, wherein in this case the infrared illuminant 104 can be synchronized with the camera 101 by exchanging synchronization signals transmitted in a wireless manner.

Due to the modular configuration of the operating unit, an offset operating control with gesture recognition can be connected to diverse controls with little effort. Since the operating unit already performs the complete evaluation of the picture data delivered by the camera, the subsequent control can be realized using a more cost-efficient and lower performance processor, or existing controls can be supplemented with a gesture control without any change.

That which is claimed:

1. An offset operating unit for a home appliance comprising:
a camera;
an evaluation unit which evaluates picture data generated by the camera for recognition of an operating gesture from a predefined set of operating gestures, wherein the operating gestures serve for operator control of the home appliance, wherein the home appliance comprises a control device for function control spaced apart from the operating unit;
an interface for wireless data transmission between the operating unit and the control device, wherein information regarding the recognized operating gesture is transmitted to the control device via the interface in a wireless manner; and
a housing in which the camera, the evaluation unit and the interface are integrated.

2. The operating unit according to claim 1, further comprising:
an energy supply unit for generating operational energy for the operating unit from an alternating magnetic field generated externally.

3. The operating unit according to claim 1, wherein:
the operating unit comprises a controllable illuminant, wherein the evaluation unit synchronizes the illuminant and the camera.

4. The operating unit according to claim 3, wherein:
the evaluation unit synchronizes the camera and a controllable illuminant provided externally in relation to the operating unit.

5. The operating unit according to claim 1, wherein:
the housing comprises a support device by means of which the operating unit is fixable to a housing of the home appliance, a cooktop or an extractor hood.

6. The operating unit according to claim 1, wherein:
the camera is a two-dimensional (2D) camera or a three-dimensional (3D) camera.

7. The operating unit according to claim 1, wherein:
the interface is an infrared interface, a Wireless Local Area Network (WLAN) interface, or a Bluetooth interface.
